(19) United States
(12) Patent Application Publication
(10) Pub. No.: US 2015/0372885 A1
(43) Pub. Date: Dec. 24, 2015

(54) METHOD, APPARATUS, AND SYSTEM FOR TRACING RESOURCE PROPAGATION

(71) Applicant: Shenzhen Development Promotion Centre for Enterprises, Shenzhen (CN)

(72) Inventor: JIMMY CHUN, Shenzhen (CN)

(73) Assignee: Shenzhen Development Promotion Centre for Enterprises, Shenzhen (CN)

(21) Appl. No.: 14/513,573

(22) Filed: Oct. 14, 2014

(30) Foreign Application Priority Data
Jun. 24, 2014 (CN) 201410286478.5

(51) Int. Cl. H04L 12/26

(52) U.S. Cl. CPC H04L 43/04; H04L 43/10

(57) ABSTRACT

The present invention, relating to the field of Internet technologies, provides a method, apparatus, and system for tracing resource propagation. The method comprises: generating a resource address pointing to a location where a resource is stored; when the resource is propagated, adding a user identifier and a propagation behavior identifier of a user propagating the resource to the resource address, and recording the user identifier and the propagation behavior identifier; and acquiring a propagation path of the resource according to the recorded user identifier and propagation behavior identifier; wherein the user identifier is used to identify a user who is logged in and propagates the current resource; and the propagation behavior identifier is used to identify a primary resource propagation behavior between the resource propagator and a previous resource propagator. According to the present invention, a user identifier and a propagation behavior identifier of a user propagating a resource are added to a resource address, and resource propagation is traced by recording a content change of the resource address, thereby conducting statistics collection for and evaluation on contributions of the user to the resource propagation.

### TECHNICAL FIELD

The present invention relates to the field of Internet technologies, and in particular, to a method, apparatus, and system for tracing resource propagation.

### BACKGROUND

A uniform resource locator (URL) is brief expression of a location where a resource can be acquired over the Internet and an access method therefor, and is a resource address of a standard resource on the Internet.

Each resource on the Internet is assigned a unique resource address, which comprises information specifying the location of the resource and how a related application program, for example, a browser processes the resource, and has been formulated in the Internet standards RFC 1738 by the World Wide Web Consortium.

Various resource platforms, for example, news websites, video websites, and music websites, are available on the Internet, and meanwhile more and more social networking platforms are being pushed. These platforms provide abundant resources, and the resources each have corresponding resource address. Users access content of the resource via the resource address, and propagate the resource address over the Internet via sharing and propagation.

At present, during a propagation of a resource over the Internet, propagation of the resource address cannot be traced, which is unfavorable to conducting statistics collection and analysis the resource propagation.

### SUMMARY

Embodiments of the present invention provide a method for tracing resource propagation, which may trace propagation of a resource and conduct statistics collection and analysis on the propagation of the resource.

An embodiment of the present invention provides a method for tracking resource propagation, comprising:

generating a resource address pointing to a location where a resource is stored;

when the resource is propagated, adding a user identifier and a propagation behavior identifier of a user propagating the resource to the resource address, and recording the user identifier and the propagation behavior identifier; and

acquiring a propagation path of the resource according to the recorded user identifier and propagation behavior identifier;

wherein the user identifier is used to identify a user who is logged in and propagates the current resource; and

the propagation behavior identifier is used to identify a primary resource propagation behavior between the resource propagator and a previous resource propagator;

An embodiment of the present invention further provides an apparatus for tracing resource propagation, comprising:

a resource address generating unit, configured to generate a resource address pointing to a location where a resource is stored;

an identifier recording unit, configured to: when the resource is propagated, add a user identifier and a propagation behavior identifier of a user propagating the resource to the resource address, and record the user identifier and the propagation behavior identifier; and

a propagation path acquiring unit, configured to acquire a propagation path of the resource according to the recorded user identifier and propagation behavior identifier;

wherein the user identifier is used to identify a user who is logged in and propagates the current resource; and

the propagation behavior identifier is used to identify a primary resource propagation behavior between the resource propagator and a previous resource propagator;

An embodiment of the present invention further provides a resource propagation system, comprising: an apparatus for tracing resource propagation, wherein the apparatus for tracing resource propagation comprises:

a resource address generating unit, configured to generate a resource address pointing to a location where a resource is stored;

an identifier recording unit, configured to: when the resource is propagated, add a user identifier and a propagation behavior identifier of a user propagating the resource to the resource address, and record the user identifier and the propagation behavior identifier; and

a propagation path acquiring unit, configured to acquire a propagation path of the resource according to the recorded user identifier and propagation behavior identifier;

wherein the user identifier is used to identify a user who is logged in and propagates the current resource; and

the propagation behavior identifier is used to identify a primary resource propagation behavior between the resource propagator and a previous resource propagator;

According to embodiments of the present invention, a user identifier and a propagation behavior identifier of a user propagating a resource are added to a resource address, and resource propagation is traced by recording a content change of the resource address, thereby conducting statistics collection for and evaluation on contributions of the user to the resource propagation during the propagation.

BRIEF DESCRIPTION OF THE DRAWINGS

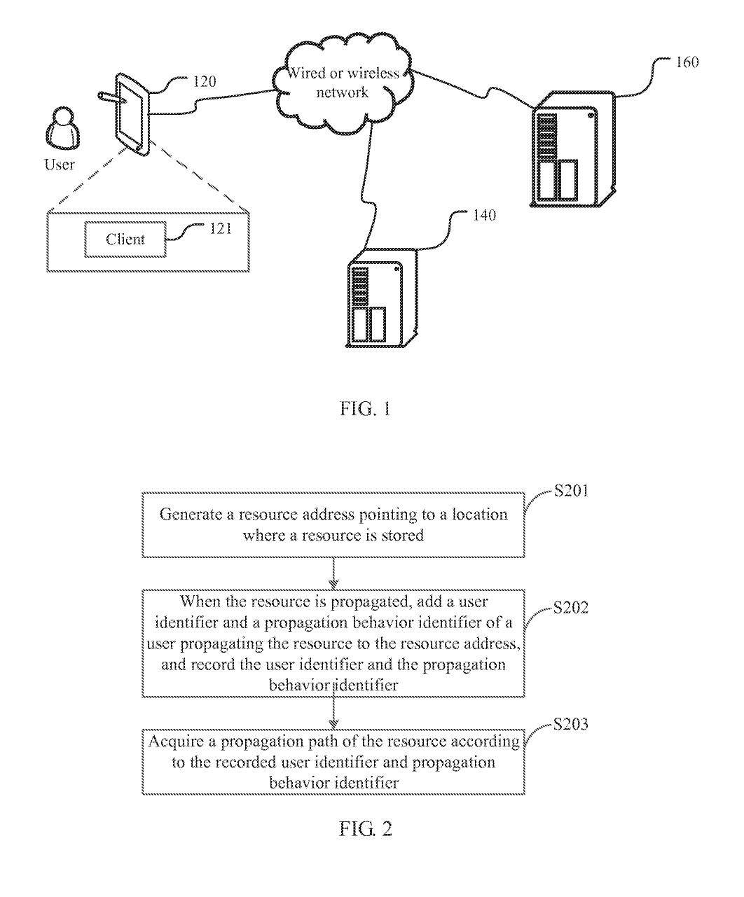

FIG. 1 is a schematic structural view of an implementation environment of a method for tracing resource propagation according to an embodiment of the present invention;

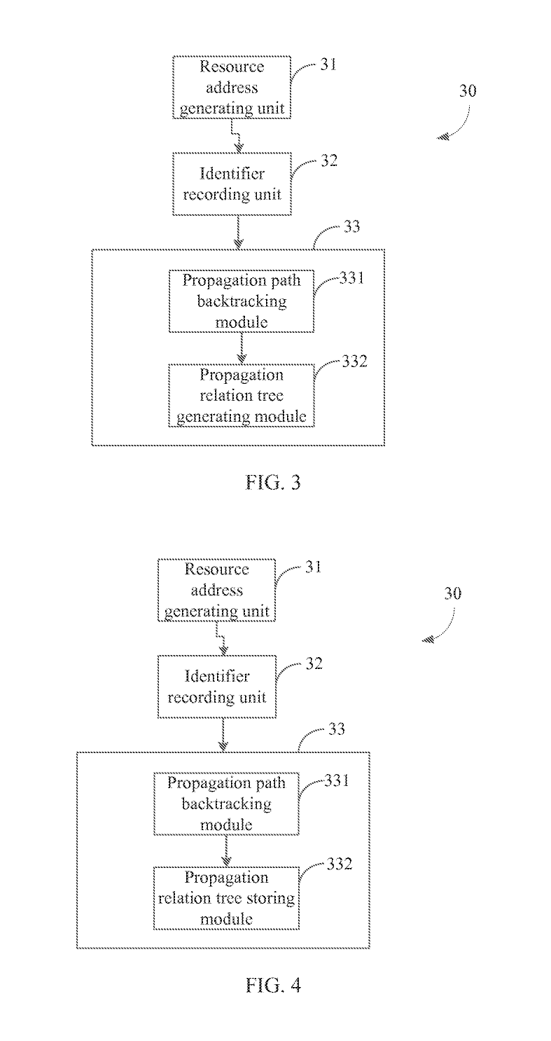

FIG. 2 is a flowchart of a method for tracing resource propagation according to an embodiment of the present invention;

FIG. 3 is a structural view of an apparatus for tracing resource propagation according to an embodiment of the present invention;

FIG. 4 is a structural view of an apparatus for tracing resource propagation according to another embodiment of the present invention; and

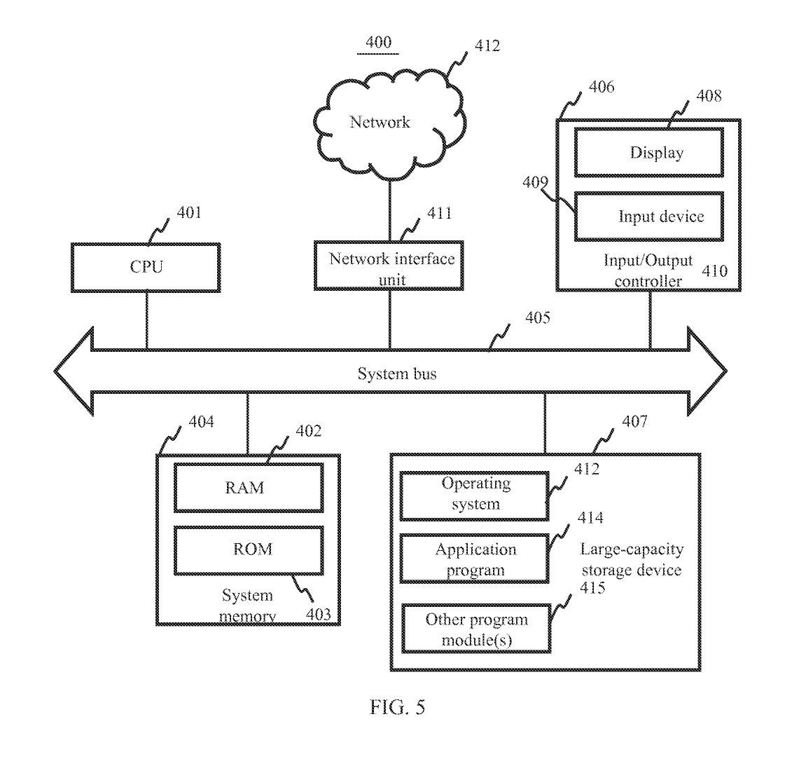

FIG. 5 is a schematic structural view of a resource propagation server according to an embodiment of the present invention.

### DETAILED DESCRIPTION

To make the objective, technical solution, and advantages of the present invention more clear, the following section describes the technical solution of the present invention in combination with the accompanying drawings and embodiments. It should be understood that the embodiments described here are only exemplary ones for illustrating the present invention, and are not intended to limit the present invention.

According to embodiments of the present invention, resource propagation is traced by recording a content change of the resource address, thereby conducting statistics collection for and evaluation on contributions of each user to the resource propagation during the propagation.

FIG. 1 illustrates an implementation environment of a method for tracing resource propagation according to an embodiment of the present invention. The implementation environment comprises a plurality of clients 121 running on a terminal device 120, a resource server 140, and a resource propagation server 160.

The clients 121 run on the terminal device 120 of a user, and may be provided by a content service provider, for example, a browser client, a forum client, an email client, a Weibo (microblog) client, or an entertainment client, an online audio player client, an online video player client, and the like.

The terminal device 120 may be a personal computer, a smart television, a smart phone, a tablet computer, an electronic book reader, a Moving Picture Experts Group Audio Layer 111 (MP3) player, a Moving Picture Experts Group Audio Layer IV (MP4) player, a TV, a laptop computer, a desktop computer, and the like.

The resource server 140 stores content of resources propagated over the Internet, and the content may be stored in formats of text, audio, video, picture, and the like.

The resource propagation server 160 generates resource addresses of the resource stored on the resource server 140, and may communicate with the clients 121 over a wired network or a wireless network. The user acquires the resource address of content from the resource propagation server 160 via the clients 121, acquires corresponding content from the resource server 140 via the resource address, and then browses, downloads or plays the resource.

In the embodiments of the present invention, the resource propagation server 160 generates a resource address pointing to a location where a resource is stored, and during the process of resource propagation, traces resource propagation by recording a content change of the resource address.

FIG. 2 is a flowchart of a method for tracing resource propagation according to an embodiment of the present invention.

In step S201, a resource address pointing to a location where a resource is stored is generated.

In the embodiments of the present invention, a resource identifier (ID) may be added to a resource address such as URL. The resource ID is an identifier pointing to a location where the resource is stored, and the location of resource data or a resource file may be searched in a resource database via the resource ID.

For example, in URL address http://bao.com/rs_{—}123, 123 is the resource ID.

In step S202, when the resource is propagated, a user identifier and a propagation behavior identifier of a user propagating the resource are added to the resource address, and the user identifier and the propagation behavior identifier are recorded.

In the embodiments of the present invention, a user identifier is used to identify a user who is logged in and propagates the current resource, which indicates who propagates the resource and is typically constituted by a user identifier using which the user logs in to a server. If the resource is original content, the resource propagator refers to a content provider.

A propagation behavior identifier is used to identify a primary resource propagation behavior between the resource propagator and the previous propagator; wherein this parameter, in combination with the user identifier of the previous propagator, may be used for a bracktracking analysis on the propagation path.

As an embodiment of the present invention, the user identifier and the propagation behavior identifier may be recorded as at least one log.

In step S203, a propagation path of the resource is acquired according to the recorded user identifier and propagation behavior identifier.

In the embodiments of the present invention, when a propagation path of a resource needs to be traced, the propagation path of the resource may be acquired according to the recorded user identifier and propagation behavior identifier. For example, in cases of large data volume, a server may trace the propagation path of each article or video each hour according to the recorded user identifier and propagation behavior identifier.

For example, when user A propagates a resource, a user identifier and a propagation behavior identifier of user A are added to an original resource address, for example, resource address http://bao.com/rs_{—}123?sharer=UserA&shareNO=aBcD1, wherein UserA is the user identifier of user A and aBcD1 is the propagation behavior identifier of user A. The server writes UserA and aBcD1 into a log (123, UserA, aBcD1, null, null), which indicates that user A propagates a resource with resource identifier 123, the propagation behavior identifier is aBcD1, and no upper-layer propagation user and no upper-layer propagation behavior identifier are specified.

When user B propagates a resource address propagated by user A, the resource address propagated by user B changes to http://bao.com/rs_{—}123?sharer=UserB&shareNo=aBcD2, wherein UserB is the user identifier of user B, and aBcD2 is the propagation behavior identifier of user B. The server writes UserB and aBcD2 into a log (123, UserB, aBcD2, UserA, aBcD1).

When user C propagates a resource address propagated by user B, the resource address propagated by user C changes to http://bao.com/rs_{—}123?sharer=UserB&shareNo=aBcD2, wherein UserC is the user identifier of user C, and aBcD3 is the propagation behavior identifier of user C. The server writes UserC and aBcD3 into a log (123, UserC, aBcD3, UserB, aBcD2).

As an embodiment of the present invention, the to may record a complete resource propagation path to trace resource propagation, which is convenient and simple in implementation.

As an embodiment of the present invention, the server may backtrack the propagation path of the resource according to the log, for the sake of not increasing data volume of the log.

In an embodiment of the present invention, the server may generate a propagation relation tree according to the backtracked propagation path of the resource, which clearly and visually presents resource propagation.

In the above examples, a propagation relation tree of the resource with the resource ID 123 is: 123, {(aBcD1, UserA), (aBcD2, UserA->UserB), (aBcd3, UserA->UserB->UserC)}.

When generating a propagation relation tree according to the log (123. UserC, aBcD3, UserB, aBcD2), the server finds a location for storing the propagation relation tree of the resource according to the resource ID 123, acquires the value of the upper-layer node aBcD2, i.e., UserA->UserB, and adds UserC based on the value, forms a node (aBcd3, UserA->UserB->UserC) and adds the node to the propagation relation tree.

In the embodiments of the present invention, the resource propagation relation tree is formed based on a time sequence, and logs of the same resource ID are processed by the server based on a time sequence. In this way, it may be ensured that corresponding upper-layer nodes may be found during processing of the logs.

In another embodiment of the present invention, the server may also store a propagation relation of the resource using a key-value structure upon backtracking the propagation path of the resource, instead of generating a propagation relation tree. The key is formed by a combination of a resource identifier and a propagation behavior identifier. For example, if the resource identifier is 123 and the propagation behavior identifier is aSd, the key may be 123.aSd or aSd_{—}123.

For example, in a resource propagation scenario of UserA->UserB->UserC, the propagation path may be traced and contribution of the user to resource propagation is quantized, by storing the following data:

123. aBcD1=>(UserA)

123. aBcD2=>(UserA, UserB)

123. aBcD3=>(UserA, UserB, UserC)

However, establishing the propagation relation tree 123, {(aBcD1, UserA), (aBcD2, UserA->UserB), (aBcd3, UserA->UserB->UserC)} may facilitate visual presentation of resource propagation.

As an embodiment of the present invention, by tracing a propagation path of a resource, quantitative evaluation may be conducted for contribution of each user on the propagation path to resource propagation.

FIG. 3 illustrates a structure of an apparatus for tracing resource propagation according to an embodiment of the present invention. For ease of description, parts relevant to the embodiments of the present invention are only illustrated.

The apparatus 30 for tracing resource propagation may be integrated or applied in a resource propagation system.

The resource propagation system may be an instant messaging tool, such a social networking website as web blog and Weibo, a forum, a news releasing system, a multimedia releasing system for video or music releasing, various content releasing APPs, an application system, or the like.

The resource propagation system is configured on one or a plurality of resource propagation servers 160, and propagates a resource address to the Internet.

During propagation of the resource address, the apparatus 30 tier tracing resource propagation generates a resource address pointing to a location where a resource is stored, and during the process of resource propagation, traces resource propagation by recording a content change of the resource address.

A resource address generating 31 generates a resource address pointing to a location where a resource is stored.

In the embodiments of the present invention, a resource ID may be added to a resource address such as URL. The resource ID is an identifier pointing to a location where the resource is stored, and the location of resource data or a resource file may be searched in a resource database via the resource

When the resource is propagated, an identifier recording unit 32 adds a user identifier and a propagation behavior identifier of a user propagating the resource to the resource address, and records the user identifier and the propagation behavior identifier.

In the embodiments of the present invention, a user identifier is used to identify a user who is logged in and propagates the current resource, which indicates who propagates the resource and is typically formed by a user identifier using which the user logs in to a server. If the resource is or content, the resource propagator refers to a content provider.

A propagation behavior identifier is used to identify a primary resource propagation behavior between the resource propagator and the previous propagator; wherein this parameter, in combination with the user identifier of the previous propagator, may be used for a backtracking analysis on the propagation path.

As an embodiment of the present invention, the identifier recording unit 32 records the user identifier and the propagation behavior identifier as at least one log.

The propagation path acquiring unit 33 acquires a propagation path of the resource according to the user identifier and the propagation behavior identifier recorded by the identifier recording unit 32.

As an embodiment of the present invention, the identifier recording unit 32 records a complete resource propagation path in the log, such that the propagation path acquiring unit 33 traces resource propagation, which is convenient and simple in implementation.

As another embodiment of the present invention, the propagation path acquiring unit 33 may backtrack the propagation path of the resource according to the log, for the sake of not increasing data volume of the log.

Referring to FIG. 3 and FIG. 4, the propagation path acquiring unit 33 comprises a propagation path backtracking module 331, which backtracks the propagation path of the resource according to the log.

As a preferred embodiment of the present invention, the propagation path acquiring unit 33 may generate a propagation relation tree according to the backtracked propagation path of the resource, which clearly and visually presents resource propagation.

As illustrated in FIG. 3, the propagation path acquiring unit 33 comprises a propagation relation tree generating module 332, which generates a propagation relation tree according to the propagation path of the resource backtracked by the propagation path backtracking module 331.

In the embodiments of the present invention, the resource propagation relation tree is formed based on a time sequence, and logs of the same resource ID are processed based on a time sequence. In this way, it may be ensured that corresponding upper-layer nodes may be found during processing of the logs.

As another embodiment of the present invention, the propagation path acquiring unit 33 may also store a propagation relation of the resource using a key-value structure upon backtracking the propagation path of the resource, instead of generating a propagation relation tree, wherein the key comprises a resource identifier and a propagation behavior identifier.

As illustrated in FIG. 4, the propagation path acquiring unit 33 comprises a propagation relation storing module 333, which stores a propagation relation of the resource using a key-value structure after the propagation path backtracking module 331 backtracks the propagation path of the resource.

As an embodiment of the present invention, by tracing a propagation path of a resource, quantitative evaluation may be conducted for contribution of each user on the propagation path to resource propagation.

Persons of ordinary skill in the art should understand that all or part of steps of the preceding methods may be implemented by hardware or hardware following instructions of programs. The programs may be stored in a non-transitory computer-readable storage medium, and may be executed by at least one processor. The storage medium may be a read only memory, a magnetic disk, or a compact disc-read only memory.

It should be noted that, during tracing a resource propagation path by the apparatus for tracing resource propagation according to the above-described embodiments, the apparatus is described by only using division of the above functional modules as an example. In practice, the functions may be assigned to different functional modules for implementation as required. To be specific, the internal structure of the resource propagation system is divided into different functional modules to implement all or part of the above-described functions. In addition, the apparatus for tracing resource propagation and the method for tracing resource propagation pertain to the same inventive concept. The specific implementation is elaborated in the method embodiments, which is not be detailed herein any further.

FIG. 5 is a schematic structural view of a server according to an embodiment of the present invention.

The resource server 140 and the resource propagation server 160 may both employ the structure illustrated in FIG. 5, to implement the method for tracing resource propagation according to the above-described embodiment.

A server 400 comprises a central processing unit (CPU) 401, a system memory 404 comprising a random access memory (RAM) 402 and a read-only memory (ROM) 403, and a system bus 405 communicatively connecting the system memory 404 and the CPU 401. The server 400 further comprises a basic input/output system (BIOS) 404 for facilitating information transmission between various components within a computer, and a large-capacity storage device 407 for storing an operating system 413, an application program 414, and one or more program modules 415.

The BIOS 404 comprises a display 408 for displaying information, and an input device 409 such as a mouse and a keyboard, for information input by a user. The display 408 and the input device 409 are both communicatively connected to the CPU 401 via an input/output (I/O) controller 410 communicatively connected to the system bus 405. The BIOS 404 may further comprise the I/O controller 410 to receive and process inputs from such devices as a keyboard, a mouse, or an electronic stylus touch pen. Analogously, the I/O controller 410 further provides outputs to a display screen, a printer, or another type of output device.

The large-capacity storage device 407 is communicatively connected to the CPU 401 via a large-capacity storage controller (not illustrated in FIG. 5) communicatively connected to the system bus 405.

The system memory 404 and the large-capacity storage device 407 may be uniformly referred to as a memory.

The large-capacity storage device 407 and the non-transitory computer-readable storage medium associated therewith provide non-volatile storage for the server 400. To be specific, the large-capacity storage device 407 may include a non-transitory compute-readable storage medium (not illustrated in FIG. 5), for example, a hard disk or a CD-ROM driver.

Without loss of generality, the non-transitory computer-readable storage medium may comprise a computer storage medium and a communication media. The computer storage medium comprises volatile and non-volatile, movable and unmovable media that are implemented using any method and technology for storing information such as non-transitory computer-readable instructions, data structures, program modules, or other data. The non-transitory computer-readable medium includes a RAM, a ROM, an EPROM, an EEPROM, a flash memory, or another such solid storage technology-based storage device; a CD-ROM, a DVD, or another such optical storage device; and a data cartridge, a magnetic card, a magnetic tape, or another such magnetic storage device. Nevertheless, a person skilled in the art may know that the non-transitory computer-readable storage medium is not limited to what are listed above.

According to the embodiments of the present disclosure, the server 400 may be further communicatively connected to a remote computer on the network by using a network such as the Internet, and may run on the computer. To be specific, the server 400 may be communicatively connected to a network 412 by using a network interface unit 411 communicatively connected to the system bus 405, or the server 400 may be communicatively connected to another type of network or a remote computer system (not illustrated in FIG. 5) by using the network interface unit 411.

The memory further comprises at least one program. The at least one program is stored in the memory, and is configured to be performed by at least one central processing unit 401. The at least one program comprises instructions for performing the method for tracing resource propagation as illustrated in FIG. 2.

Persons of ordinary skill in the art should understand that all or part of steps of the preceding methods may be implemented by hardware or hardware following instructions of programs. The programs may be stored in a non-transitory computer-readable storage medium, and may be executed by at least one processor. The storage medium may be a read only memory, a magnetic disk, or a compact disc-read only memory.

According to embodiments of the present invention, a user identifier and a propagation behavior identifier of a user propagating a resource are added to a resource address, and resource propagation is traced by recording a content change of the resource address, thereby conducting statistics collection for and evaluation on contributions of the user to the resource propagation during the propagation.

Described above are merely preferred embodiments of the present invention, but are not intended to limit the present invention. Any modification, equivalent replacement, or improvement made without departing from the spirit and principle of the present invention should fall within the protection scope of the present invention.

What is claimed is:

1. A method for tracing resource propagation, comprising:
generating a resource address pointing to a location where a resource is stored;
when the resource is propagated, adding a user identifier and a propagation behavior identifier of a user propagating the resource to the resource address, and recording the user identifier and the propagation behavior identifier; and
acquiring a propagation path of the resource according to the recorded user identifier and propagation behavior identifier;
wherein the user identifier is used to identify a user who is logged in and propagates the current resource; and
the propagation behavior identifier is used to identify a primary resource propagation behavior between the resource propagator and a previous resource propagator.

2. The method according to claim 1, wherein the user identifier and the propagation behavior identifier are recorded as a log.

3. The method according to claim 2, wherein the log records a complete resource propagation path.

4. The method according to claim 2, wherein the acquiring a propagation path of the resource comprises:
backtracking the propagation path of the resource according to the log.

5. The method according to claim 4, wherein the acquiring a propagation path of the resource further comprises:
generating a propagation relation tree according to the backtracked propagation path of the resource.

6. The method according to claim 4, wherein the acquiring a propagation path of the resource further comprises:
storing a propagation relation of the resource using a key-value structure after the propagation path backtracking module backtracks the propagation path of the resource;
wherein the key comprises a resource identifier and a propagation behavior identifier.

7. An apparatus for tracing resource propagation, comprising:
a resource address generating unit, configured to generate a resource address pointing to a location where a resource is stored;
an identifier recording unit, configured to: when the resource is propagated, add a user identifier and a propagation behavior identifier of a user propagating the resource to the resource address, and record the user identifier and the propagation behavior identifier; and
a propagation path acquiring unit, configured to acquire a propagation path of the resource according to the recorded user identifier and propagation behavior identifier;
wherein the user identifier is used to identify a user who is logged in and propagates the current resource; and
the propagation behavior identifier is used to identify a primary resource propagation behavior between the resource propagator and a previous resource propagator;

8. The apparatus according to claim 7, wherein the identifier recording unit records the user identifier and the propagation behavior identifier as a log.

9. The apparatus according to claim 8, wherein the log records a complete resource propagation path.

10. The apparatus according to claim 8, wherein the propagation path acquiring unit comprises:
a propagation path backtracking module, configured to backtrack the propagation path of the resource according to the log.

11. The apparatus according to claim 10, wherein the propagation path acquiring unit further comprises:
a propagation relation tree generating module, configured to generate a propagation relation tree according to the propagation path of the resource backtracked by the propagation path backtracking module.

12. The apparatus according to claim 10, wherein the propagation path acquiring unit further comprises:
a propagation relation storing module, configured to store a propagation relation of the resource using a key-value structure after the propagation path backtracking module backtracks the propagation path of the resource;
wherein the key comprises a resource identifier and a propagation behavior identifier.

13. A resource propagation system, comprising: an apparatus for tracing resource propagation, wherein the apparatus for tracing resource propagation comprises:
a resource address generating unit, configured to generate a resource address pointing to a location where a resource is stored;
an identifier recording unit, configured to: when the resource is propagated, add a user identifier and a propagation behavior identifier of a user propagating the resource to the resource address, and record the user identifier and the propagation behavior identifier; and
a propagation path acquiring unit, configured to acquire a propagation path of the resource according to the recorded user identifier and propagation behavior identifier;
wherein the user identifier is used to identify a user who is logged in and propagates the current resource; and
the propagation behavior identifier is used to identify a primary resource propagation behavior between the resource propagator and a previous resource propagator;

14. The system according to claim 13, wherein the identifier recording unit records the user identifier and the propagation behavior identifier as a log.

15. The system according to claim 14, wherein the log records a complete resource propagation path.

16. The system according to claim 14, wherein the propagation path acquiring unit comprises:
a propagation path backtracking module, configured to backtrack the propagation path of the resource according to the log.

17. The system according to claim 16, wherein the propagation path acquiring unit further comprises:
a propagation relation tree generating module, configured to generate a propagation relation tree according to the propagation path of the resource backtracked by the propagation path backtracking module.

18. The system according to claim 16, wherein the propagation path acquiring unit further comprises:
a propagation relation storing module, configured to store a propagation relation of the resource using a key-value structure after the propagation path backtracking module backtracks the propagation path of the resource;
wherein the key comprises a resource identifier and a propagation behavior identifier.
